(19) United States
(12) Patent Application Publication
(10) Pub. No.: US 2011/0311699 A1
(43) Pub. Date: Dec. 22, 2011

(54) Tabletop bun and tortilla steamer and method

(76) Inventors: Henry T. Ewald, Roselle, IL (US); Paul G. Simmons, Glen Ellyn, IL (US)

(21) Appl. No.: 13/199,278

(22) Filed: Aug. 24, 2011

Related U.S. Application Data
(63) Continuation-in-part of application No. 12/798,809, filed on Apr. 12, 2010.

(51) Int. Cl. A23L 1/01; A23L 1/00

(52) U.S. Cl. 426/511; 99/426

(57) ABSTRACT

A cooking device is provided for steaming food items and transferring steamed food items from the device to a work surface. The device includes a platform for placing food items thereon mounted to a support for movement to and from food steaming and food removal positions. A method of steaming food items is provided using the cooking device. A method of transferring steamed food items from the cooking device to a container or a work surface is also provided.

### CROSS REFERENCE TO RELATED APPLICATIONS

This application is a continuation-in-part of U.S. application Ser. No. 12/798,809, filed on Apr. 12, 2010, pending, the entire disclosure of the foregoing application is hereby expressly incorporated by reference.

### FIELD OF THE INVENTION

The present invention relates to food steaming devices and methods of steaming food in and removing food from food steaming devices. More particularly, the present invention relates to food steaming devices and methods for transferring food items from the food steaming devices to a work surface.

### BACKGROUND OF THE INVENTION

When steaming a food item in a food steaming device, it is often desirable to transfer the steamed food item quickly to a container on a work surface, to further prepare the food item for serving. Existing food steamers typically include a food-supporting tray that is separate from and freely slidable into and out of a steam injector that comprises a cabinet assembly. At the end of a steaming cycle, the tray is slid out of the cabinet assembly and steamed food items are typically transferred by hand from the hot tray to an appropriate container, resulting in additional manual handling of the food item. Manual handling potentially may adversely affect the appearance of the steamed food item.

A need therefore exists for a food steaming device adapted for quick removal of steamed food items from the device. Preferably, the device should be adapted for transfer of steamed food items from the device to a work surface.

### BRIEF SUMMARY OF THE INVENTION

In accordance with one aspect of the invention, a device for steaming a food item is provided. The device for steaming a food item comprises a food item platform, a platform support, a platform hinge connecting the food item platform to the platform support, wherein the food item platform is pivotable between a food steaming position and a food removal position, a food item support riser connected to the food item platform, and a steam source communicating with a steam outlet, the steam outlet configured to direct steam onto the food item platform when the food item platform is in the food steaming position.

In one aspect of the invention, the food item support riser is curved.

In another aspect of the invention, the food item support riser is generally u-shaped and is generally symmetrical about a vertical axis through the food item platform.

In another aspect of the invention, the food item platform is generally horizontal when in the food steaming position. The food item platform may be pivotable at least 180 degrees from the food steaming position.

The food item platform may comprise a first steaming dome and a second steaming dome; wherein the first steaming dome and the second steaming dome direct steam through the food item platform and onto the food item. The first steaming dome and the second steaming dome may be sized to direct steam substantially uniformly onto a bun piece. Typically, the food item support riser is located between the first steaming dome and the second steaming dome. The first steaming dome and the second steaming dome may be sized to direct steam substantially uniformly onto a bun piece or onto a tortilla on the food item support riser.

In one embodiment, the platform support comprises a plurality of platform mounts to allow the device to be mounted alternatively adjacent to a tabletop, mounted to the tabletop, and placed on the tabletop.

In one embodiment, the device includes a cover, wherein the cover cooperatively engages the food item platform defining a cavity, the cavity comprising a seal to substantially retain steam in the cavity when the device is in the food steaming position.

In another embodiment, the food item platform comprises a food steaming panel comprising a steam permeable material. The food steaming panel may comprise a steaming dome that directs steam through the food item platform and onto the food item.

In accordance with another embodiment, the device includes an indicator. The indicator may be an LED indicator light. Alternatively, the indicator may be an audible signal indicator. The device may also include both an LED indicator light and an audible signal indicator.

In another aspect of the invention, a method of producing a steamed food item is provided. The method includes providing a device for steaming food that comprises a food item platform; a platform support; a platform hinge connecting the food item platform to the platform support, wherein the food item platform is pivotable between a food steaming position and a food removal position; a food item support riser connected to the food item platform; and a steam source communicating with a steam outlet, the steam outlet configured to direct steam onto the food item platform when the food item platform is in the food steaming position. The food item platform is placed in the food steaming position. A food item is placed on the food item support riser. Steam is directed from the steam source through the steam outlet and onto the food item for a period of time sufficient to at least substantially steam the food item. The food item is removed from the food item support riser.

In one aspect of the invention, the period of time sufficient to at least substantially steam the food item is approximately 12 seconds.

The method may further comprise signaling that the steaming of the food item is at least substantially completed.

In a further embodiment, a cover movable between an open position and a closed position is provided. The cover is moved to the open position to permit placing a food item on the food item platform. The cover is then moved to the closed position to define a cavity, the cavity comprising the food item and configured to at least substantially retain steam. After steam is directed from the steam source, the cover is moved to the open position to permit moving the food item platform from the food steaming position to the food removal position.

### BRIEF DESCRIPTION OF THE DRAWINGS

FIG. 1 is a perspective view of a steaming device according to one aspect of the present invention.

FIG. 2 is a perspective view of a steaming device according to another aspect of the present invention.

FIG. 2a is a schematic representation of a microprocessor controlled steam source according to the present invention.

FIG. 3 is a perspective view of a steaming device according to another aspect of the present invention.

FIG. 4 is a perspective view of a steaming device according to another aspect of the present invention.

FIG. 5 is a perspective view of a steaming device according to another aspect of the present invention.

FIG. 6 is a perspective view of a platform support according to one aspect of the present invention.

FIG. 7 is a perspective view of a food item platform for a steaming device according to the present invention.

FIG. 8 is a perspective view of a steam permeable panel for a steaming device according to the present invention.

FIG. 9 is a perspective view of a steam enclosure cover for a steaming device according to the present invention.

FIG. 10 is a perspective view of a steaming device according to another aspect of the present invention.

FIG. 11 is a perspective view of a steaming device according to another aspect of the present invention.

FIG. 12 is a perspective view of a steaming device according to another aspect of the present invention.

FIG. 13 is a perspective view of a steaming device according to another aspect of the present invention.

FIG. 14 is a perspective view of a steaming device according to another aspect of the present invention.

FIG. 15 is a perspective view of a steaming device according to another aspect of the present invention.

FIG. 16 is a perspective view of a steaming device according to another aspect of the present invention.

FIG. 17 is a perspective view of a steaming device according to another aspect of the present invention.

FIG. 18 is a perspective view of a steaming device according to another aspect of the present invention.

FIG. 19 is a perspective view of a platform support according to another aspect of the present invention.

FIG. 20 is a perspective view of a food item platform for a steaming device according to the present invention.

FIG. 21 is a perspective view of a steam permeable panel for a steaming device according to the present invention.

FIG. 22 is a perspective view of a steaming device according to another aspect of the present invention.

FIG. 23 is a perspective view of a steaming device according to another aspect of the present invention.

FIG. 24 is a perspective view of a steaming device according to another aspect of the present invention.

FIG. 25 is a perspective view of a steaming device according to another aspect of the present invention.

### DETAILED DESCRIPTION OF THE INVENTION

Tabletop food item steamers, methods for using them to steam food items, and methods for transferring steamed food items are described in this section.

With reference to the Figures generally, a tabletop food steaming device 10 adapted for quick steaming, removal, and transfer of food items from device 10 to a work surface is described. In particular, steaming device 10 is shown in various orientations to illustrate its structure and function, as well as a method of using the device.

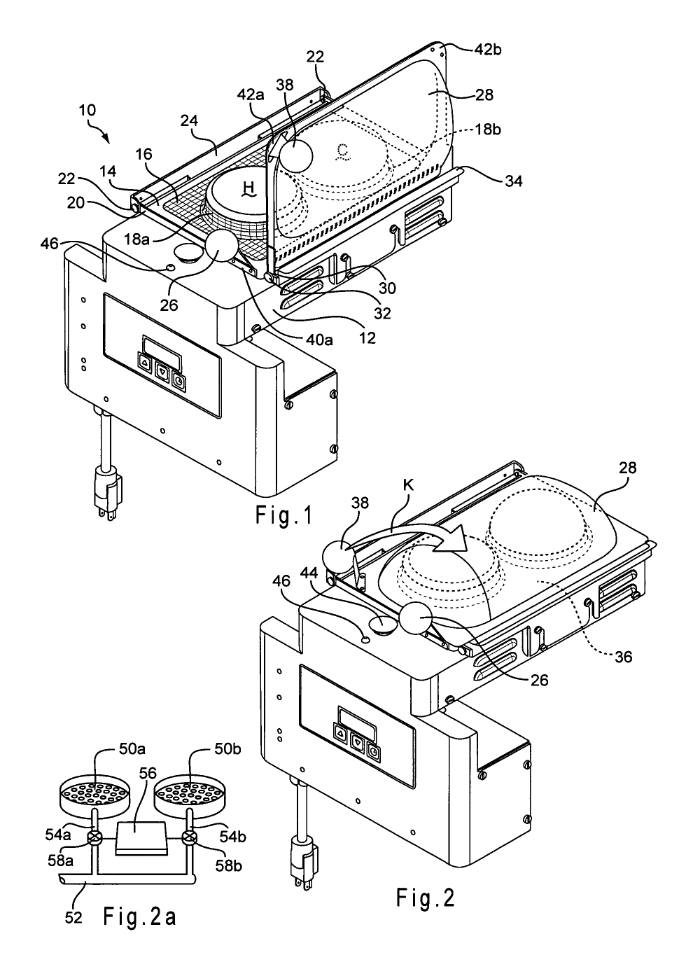

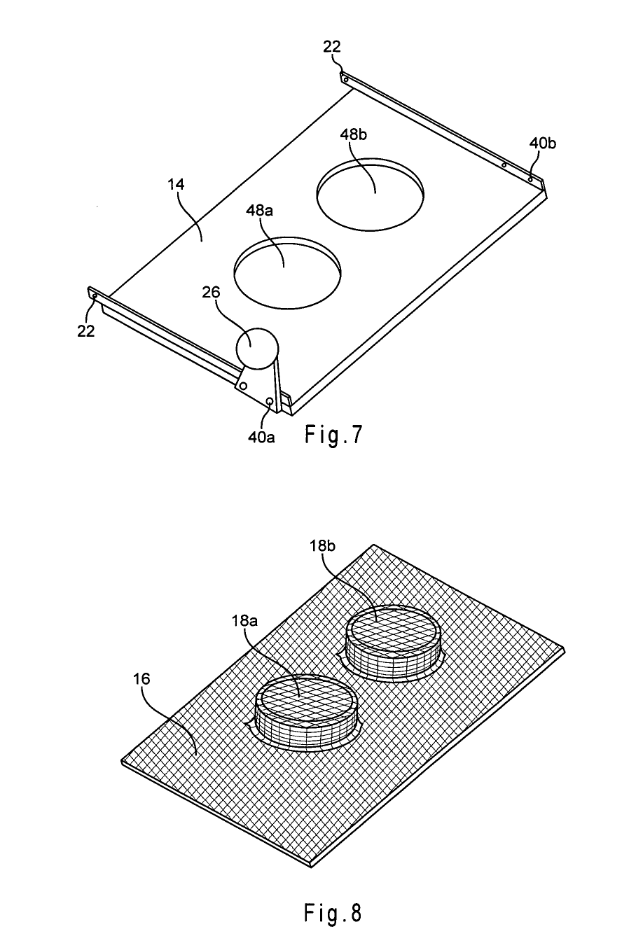

As illustrated in FIGS. 1-6, steaming device 10 includes a platform support 12 which supports a food item platform 14. Food item platform 14 is illustrated separately in detail in FIG. 7. Food item platform 14 typically is essentially rectangular in shape. A steam permeable panel 16 having steaming domes 18a and 18b is attached to food item platform 14. Steam permeable panel 16 is adapted to support food items to be steamed on steaming domes 18a and 18b. Steaming domes 18a and 18b are adapted to receive a food item placed thereon. Typically, steaming domes 18a and 18b are sized to direct steam substantially uniformly onto a food item such as a bun crown or heel.

Steam permeable panel 16, shown separately in detail in FIG. 8, may be formed of any suitable steam permeable material preferably having a relatively low thermal conductivity and a relatively high temperature resistance, including but not limited to silicone, nylon or metal and may be in the form of a mesh or screen to allow steam to readily pass therethrough.

Steam permeable panel 16 may be attached to food item platform 14 in any suitable manner, including, but not limited to, the application of a thermally resistant adhesive or a mechanical fastener.

Food item platform 14 is connected to platform support 12 via a platform hinge 20. Platform hinge 20 includes at least one platform hinge attachment 22 mounted to a platform hinge bracket 24, attaching food item platform 14 to platform support 12. Platform hinge 20 allows food item platform 14 to be rotated about an essentially horizontal axis in the direction of arrow L by an operator using a platform handle 26. Typically, platform hinge 20 allows food item platform 14 to be rotated at least 180 degrees about an essentially horizontal axis.

When food item platform 14 is substantially engaged with platform support 12 as illustrated in FIG. 1, food item platform 14 is in the food steaming position. Typically, food item platform 14 is generally horizontal when in the food steaming position. When food item platform 14 is rotated and disengaged from platform support 12 as illustrated in FIG. 4, food item platform 14 is in the food removal position. Typically, food item platform 14 can be rotated at least about 180 degrees between the food steaming position and the food removal position. Typically, the food removal position is approximately at least 135 degrees offset from the food steaming position.

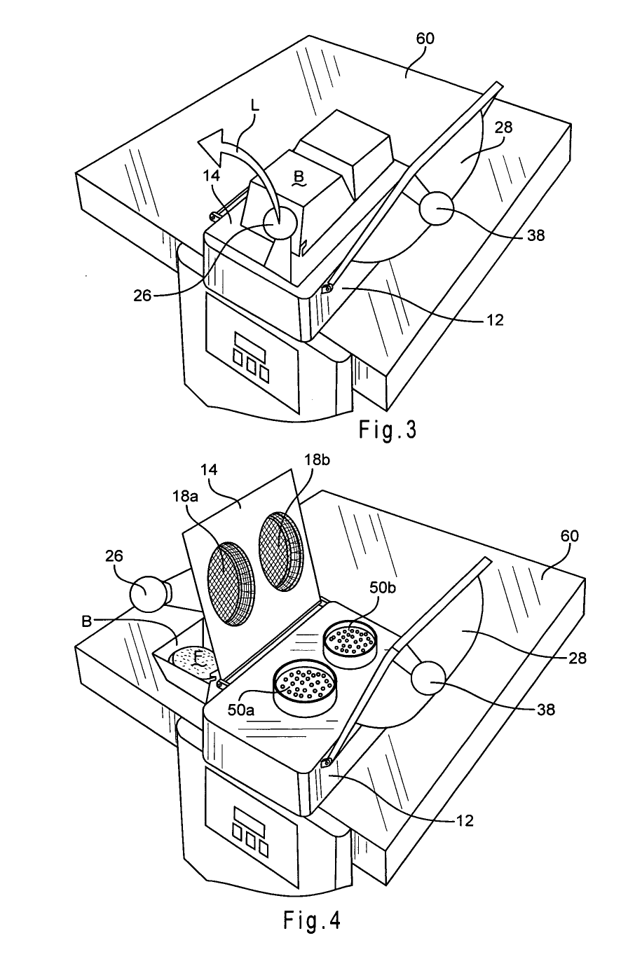

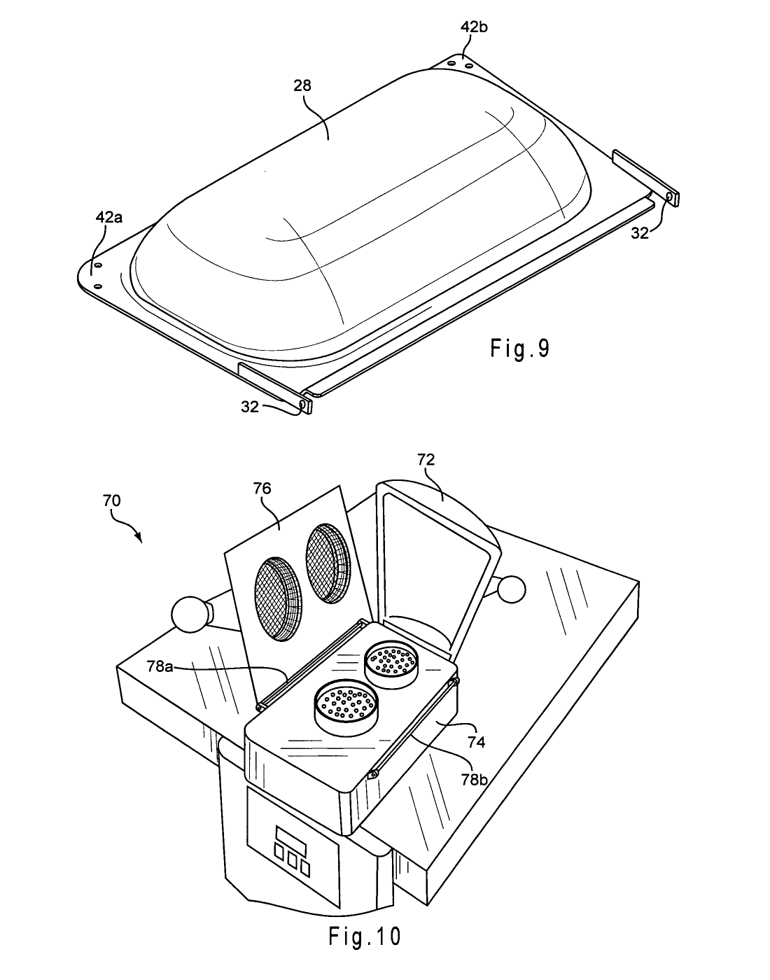

Steaming device 10 further includes a cover 28. Cover 28 is shown separately in detail in FIG. 9. Cover 28 is connected to platform support 12 via a cover hinge 30. Cover hinge 30 includes at least one cover hinge attachment 32 mounted to a cover hinge bracket 34, and functions to attach cover 28 to platform support 12. When cover 28 is in the closed position, as illustrated in FIG. 2, it essentially covers food item platform 14 to form a cavity 36. Typically, cover 28 is essentially rectangular in shape and has approximately the same width and length as food item platform 14. Cover hinge 30 allows cover 28 to be opened, exposing food item platform 14. Cover hinge 30 allows the cover 28 to be rotated about an essentially horizontal axis by an operator using a cover handle 38. Cover hinge 30 allows cover 28 to be rotated at least 90 degrees about an essentially horizontal axis in the direction of arrow K. Typically, cover hinge 30 allows cover 28 to be rotated at least 135 degrees about an essentially horizontal axis, providing clearance to allow food item platform 14 to be rotated via platform hinge 20.

Cover hinge 30 typically attaches cover 28 to platform support 12 on a different side from where platform hinge 20 attaches food item platform 14 to platform support 12. Cover hinge 30 can attach cover 28 to platform support 12 in a manner to rotate in a different direction from food item platform 14. Typically, cover hinge 30 attaches cover 28 to platform support 12 in a manner to rotate in the opposite direction from food item platform 14. As illustrated in FIG. 1, food item platform 14 rotates in a counterclockwise direction, towards the left, and cover 28 rotates in a clockwise direction, towards the right.

Optionally, platform hinge attachments 22 and cover hinge attachments 32 are adapted to be selectively mounted to either platform hinge bracket 24 or cover hinge bracket 34, interchangeable between the hinge brackets. Preferably, platform hinge attachment 22 can be connected to either platform hinge bracket 24 or cover hinge bracket 34 and cover hinge attachment 32 can be mounted to either platform hinge bracket 24 or cover hinge bracket 34. Food item platform 14 is situated in either a leftward pivoting or rightward pivoting orientation, allowing food item platform 14 to be rotated in either the clockwise or counterclockwise direction depending on the preferred mode of operation, and accommodating both right-handed and left-handed human operators. Cover 28 is situated in either a leftward pivoting or rightward pivoting orientation, allowing cover 28 to be rotated in either the clockwise or counterclockwise direction depending on the preferred mode of operation.

Cover 28 includes alternate handle mounts 42a and 42b at adjacent corners to allow cover handle 38 to be attached at the appropriate corner to be accessible from the front of steaming device 10 in its leftward pivoting or rightward pivoting orientations. As illustrated in FIG. 7, food item platform 14 further includes similar alternate handle mounts 40a and 40b at adjacent corners to allow platform handle 26 to be attached at the appropriate corner to be accessible from the front of steaming device 10 in its leftward pivoting or rightward pivoting orientations. FIG. 6 is an illustration of platform support 12 with food item platform 14 and cover 28 detached therefrom, ready for each of food item platform 14 and cover 28 to be mounted to either hinge bracket 24 or hinge bracket 34 as desired.

Steaming device 10 also includes a button 44 for activating steaming device 10. Steaming device 10 also includes an LED indicator 46 which indicates when the steaming process is complete. The steaming device may also include any other type of suitable indicator that steaming is complete, including, but not limited to, an audible signal.

FIG. 2 illustrates steaming device 10 in the closed position. Cover 28 is pivotally rotated to engage with platform support 12, forming cavity 36. Preferably, cover 28 cooperatively engages with platform support 12 to form steaming cavity 36 when steaming device 10 is in the closed position, to at least substantially retain steam inside cavity 36 during steaming. Steaming is initiated by an operator by activating button 44 or triggering any other appropriate actuator. A controlled quantity of steam is injected through steam permeable panel 16 once steaming is initiated. Typically, a food item is located on steaming domes 18a and 18b and is steamed from the controlled quantity of steam. The food item can be any food item that is to be steamed. Typically the food item is a bun piece, such as a bun heel H or a bun crown C.

As illustrated in FIG. 7, to permit passage of steam from a steam source into heel H and crown C, food item platform 14 includes platform openings 48a and 48b, which communicate with steaming domes 18a and 18b, respectively. Platform support 12 includes steam outlets 50a and 50b, as illustrated in FIG. 4, which communicate with steaming domes 18a and 18b, respectively.

Any suitable steam source may be configured in communication with steam outlets 50a and 50b to provide controlled quantities of steam for injection into food items in steaming device 10. Each steam outlet may have its own steam source or may share a common steam source. Referencing schematic FIG. 2a, a common steam source 52 supplies steam to both steam outlets 50a and 50b, via respective heated sinks 54a and 54b. A microprocessor control system 56 is provided for directing solenoids 58a and 58b to provide a water pulse to one of associated heated sinks 54a and 54b about 0.1 second before providing a water pulse to the other heated sink. Such staggering of water pulses has been found to promote more uniform water input to each heated sink than simultaneous water pulses and consequently, a more uniform quantity or shot of steam from heated sinks 54a and 54b.

As illustrated in FIG. 3, steaming device 10 includes platform support 12, food item platform 14, and cover 28. Cover 28 is in an open position, and clamshell box B is in place over the steamed food item to be transferred to a work surface 60 together with the steamed food item. Any appropriate packaging may be placed over the steamed food item. Typically, the packaging is a clamshell box. Placing packaging over the steamed food item prior to transferring the food item to a work surface is advantageous when it is desired to prevent the food item from directly contacting the work surface or the hand of a human operator. The work surface can be any appropriate surface for holding or preparing the food item. Typically the work surface is an approximately horizontal surface or table.

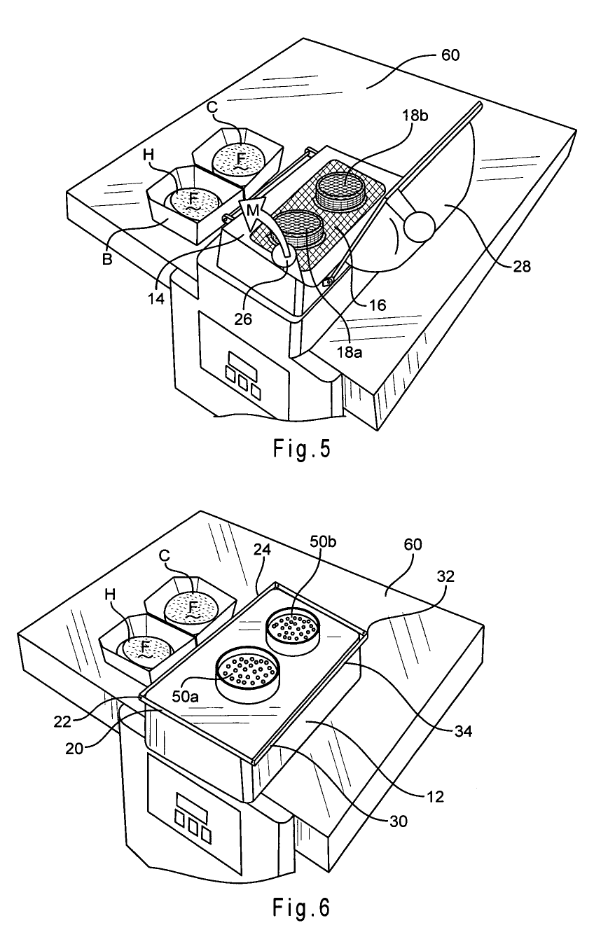

As illustrated in FIG. 4, steaming device 10 includes platform support 12, food item platform 14, steaming domes 18a and 18b, steam outlets 50a and 50b, and cover 28. Cover 28 is in the open position. Food item platform 14 is shown in an open position. Clamshell box B is on work surface 60, transferred to work surface 60 from the rotational momentum to the steamed food items and clamshell box B during rotation of food item platform 14 from the food steaming position to the food removal position. Clamshell box B contains bun heel H and crown C with cut faces F facing upward as illustrated in FIGS. 4-5 to facilitate placement of sandwich ingredients on cut faces F.

FIG. 5 illustrates steaming device 10 in the food steaming position, after steamed buns have been transferred to work surface 60. Steaming device 10 can now receive another food item to be steamed. Food item platform 14 can be rotated about an essentially horizontal axis in the direction of arrow M by an operator using a platform handle 26.

FIG. 6 illustrates platform support 12. Platform support 12 includes platform hinge 20 and cover hinge 30. Platform hinge 20 includes platform hinge attachment 22 and platform hinge bracket 24. Cover hinge 30 includes cover hinge attachment 32 and cover hinge bracket 34. Platform support 12 is ready for each of food item platform 14 and cover 28 to be mounted to either hinge 20 or 30, as desired.

FIG. 7 illustrates food item platform 14. Food item platform 14 includes platform openings 48a and 48b, which are slightly larger than steaming domes 18a and 18b as illustrated in FIG. 5. Platform hinge attachments 22 are adapted to connect food item platform 14 to a platform support of a steaming device. Food item platform 14 also includes platform handle 26. Platform handle 26 is attached to food item platform 14 via handle mount 40a. Alternatively, platform handle 26 can be attached to food item platform 14 via handle mount 40b.

FIG. 8 illustrates steam permeable panel 16. Steam permeable panel 16 includes steaming domes 18a and 18b. Steaming domes 18a and 18b are of the appropriate size and shape to accept placement of a food item thereon. Typically, steaming domes 18a and 18b are slightly larger than a hamburger bun and accept placement of a hamburger bun thereon.

FIG. 9 illustrates cover 28. Cover 28 is dome shaped to form a cavity when cover 28 is in the closed position and engaged with a food item platform. Cover 28 is typically a curved dome. The curved dome prevents water from falling from the cover back onto the steamed food item. This improves the quality of the food item and prevents the food item from getting soggy. This is especially important for a bun or other bread product which could easily become soggy and of a decreased quality if water were permitted to drip thereon. Cover 28 further includes cover hinge attachments 32 to allow cover 28 to be attached to a platform support on a steaming device. Cover 28 includes alternate handle mounts 42a and 42b at adjacent corners to allow a cover handle to be attached at the appropriate corner to be accessible from the front of a steaming device in its leftward pivoting or rightward pivoting orientations.

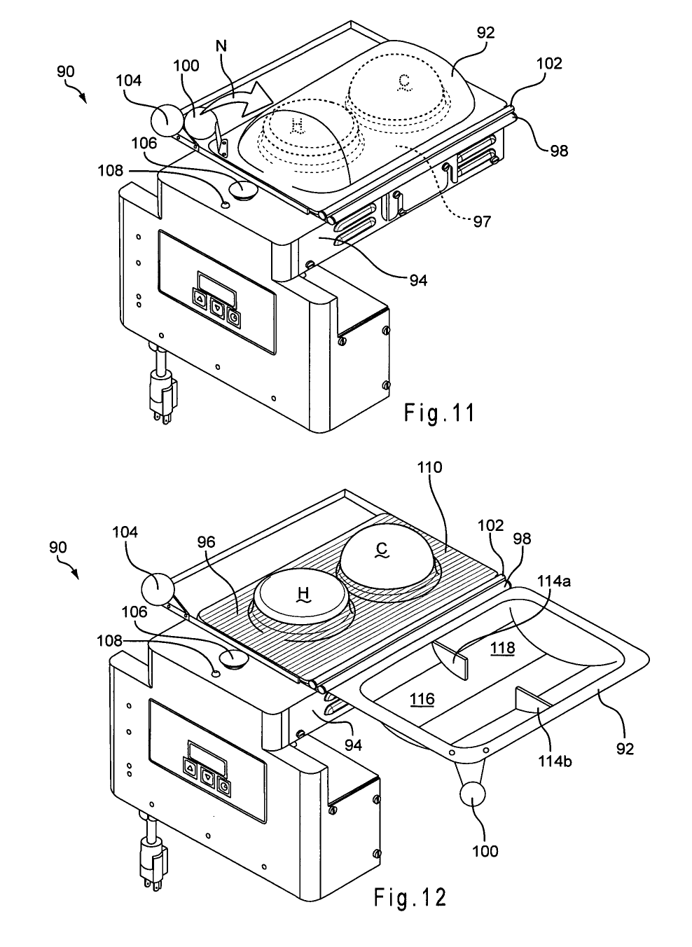

In another embodiment, as illustrated in FIG. 10, food steaming device 70 is provided. Food steaming device 70 includes a cover 72 configured to pivot rearwardly away from a platform support 74, at an approximate right angle to the pivoting direction of a food item platform 76. Platform support 74 is approximately rectangular shaped and includes a width and a length. Cover 72 is attached to platform support 74 along the width portion of platform support 74. Food item platform 76 is attached to platform support 74 along the length portion of platform support 74. Food item platform 76 may be freely mounted to either of two hinge brackets 78a and 78b, for leftward pivoting as shown or for rightward pivoting, without the need to switch the mounting position of cover 72.

In another embodiment, as illustrated in FIGS. 11-14, food steaming device 90 is provided. Food steaming device 90 includes a cover 92 configured to pivot away from a platform support 94 in the direction of arrow N. Food item platform 96 is configured to pivot open in the direction of arrow O. Cover 92 pivots open in the same direction as food item platform 96. When cover 92 is in the closed position, as illustrated in FIG. 11, it essentially covers food item platform 96 to form a cavity 97. Platform support 94 is approximately rectangular shaped and includes a width and a length. Cover 92 is attached to platform support 94 along the length portion of platform support 94 via a cover hinge 98. Cover hinge 98 allows cover 92 to be rotated about an essentially horizontal axis by an operator using cover handle 100. Typically, cover hinge 98 allows cover 92 to be rotated at least 180 degrees about an essentially horizontal axis. Food item platform 96 is attached to platform support 94 along the length portion of platform support 94 via a platform hinge 102. Platform hinge 102 allows food item platform 96 to be rotated about an essentially horizontal axis by an operator using platform handle 104. Typically, platform hinge 102 allows food item platform 96 to be rotated at least 180 degrees about an essentially horizontal axis. Cover hinge 98 is adjacent to and generally parallel to platform hinge 102.

Steaming device 90 also includes a button 106 for activating steaming device 90. Steaming device 90 also includes an LED indicator 108 which indicates when the steaming process is complete. The steaming device may also include any other type of suitable indicator that steaming is complete, including, but not limited to, an audible signal.

Cover 92 is in the open position as illustrated in FIGS. 12-14. A steam permeable panel 110 having steaming domes 112a and 112b is attached to food item platform 96. Steam permeable panel 110 is adapted to support food items to be steamed on steaming domes 112a and 112b. Steaming domes 112a and 112b are adapted to receive a food item placed thereon. Typically, steaming domes 112a and 112b are sized to direct steam substantially uniformly onto a food item such as a bun crown C or bun heel H.

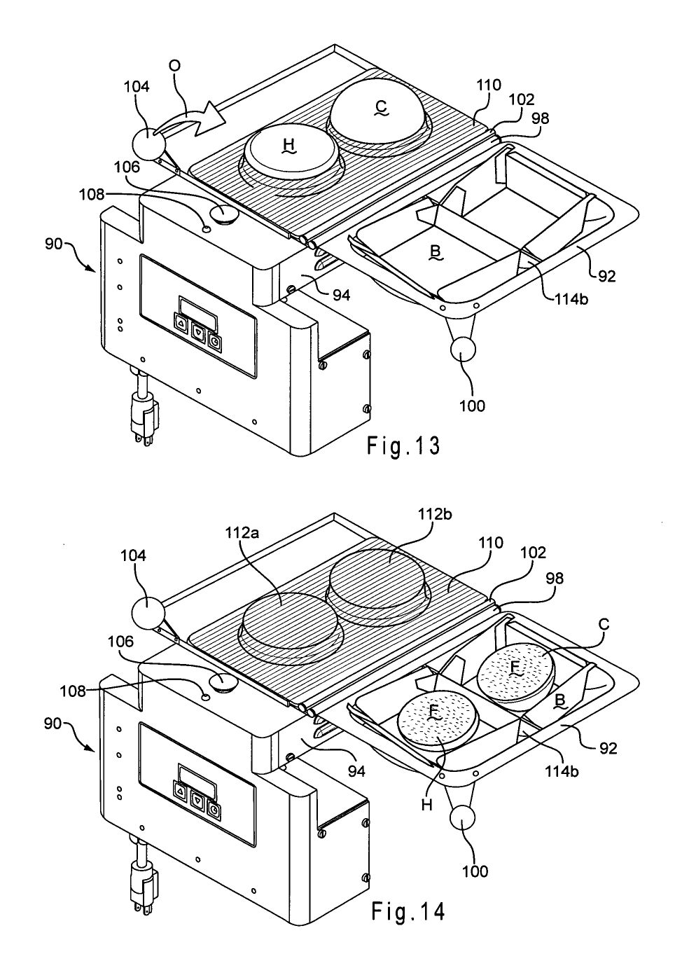

Cover 92 also includes partitions 114a and 114b. Partitions 114a and 114b are located approximately in the middle of the length of cover 92, and extend across a portion of the width of cover 92. Partitions 114a and 114b are approximately linearly arranged, and are configured to allow for the location of a container on cover 92. Partitions 114a and 114b divide cover 92 into a left portion 116 and a right portion 118. Left portion 116 is approximately the same size as right portion 118. As illustrated in FIGS. 13-14, open clamshell container B is configured over partitions 114a and 114b with a bottom portion of clamshell container B on one side of partitions 114a and 114b and a top portion of clamshell container B on the other side of partitions 114a and 114b. The bottom and top portions of clamshell box B are configured to accept a food item from steaming domes 112a and 112b, such as bun crown C and bun heel H, as illustrated in FIG. 14.

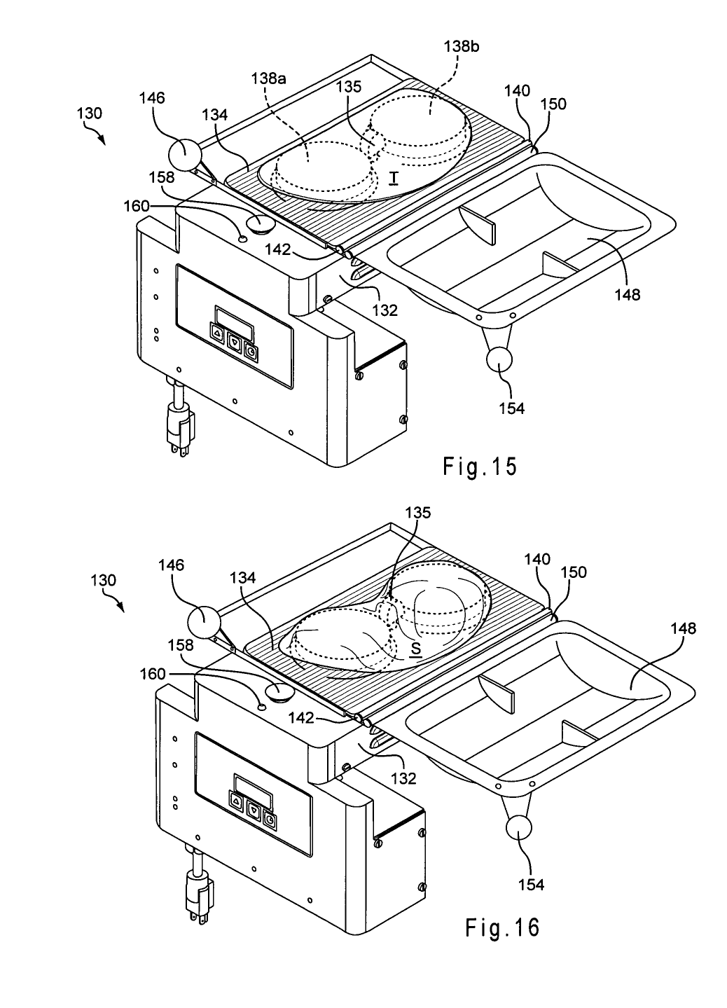

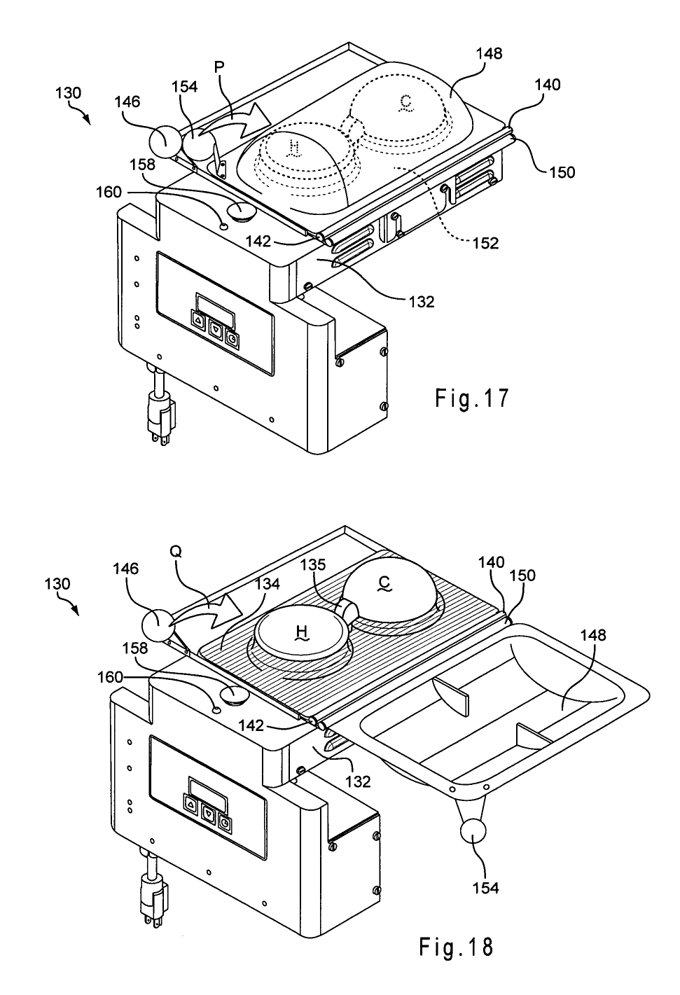

In another embodiment, as generally illustrated in FIGS. 15-23, food steaming device 130 is provided. Food steaming device 130 includes a platform support 132 which supports a food item platform 134. Food item platform 134 is illustrated separately in detail in FIG. 20. Food item platform 134 is typically essentially rectangular in shape. Food item platform 134 includes a food item support riser 135.

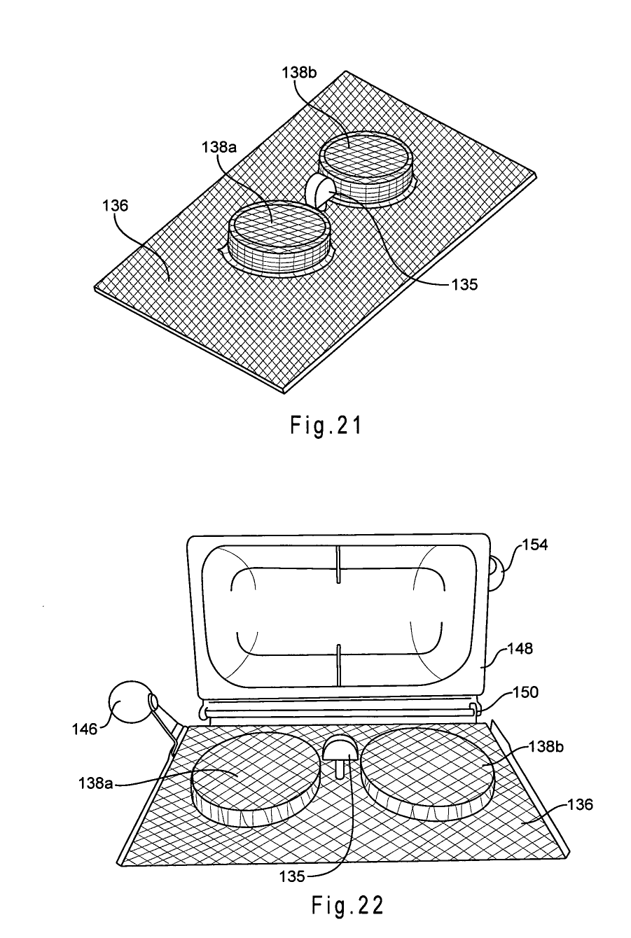

A steam permeable panel 136 having a first steaming dome 138a and a second steaming dome 138b is attached to food item platform 134. Steam permeable panel 136 is illustrated separately in detail in FIG. 21.

Food item support riser 135 is adapted to support food items to be steamed in food steaming device 130. Typically, food item support riser 135 is adapted to support a tortilla. Food item support riser 135 is typically located between steaming domes 138a and 138b. Typically food item support riser 135 is any appropriate height and size to support a tortilla T above steaming domes 138a and 138b. Food item support riser 135 is curved to support a tortilla T in a manner that prevents tortilla T from ripping upon placement on food item support riser 135. Typically, food item support riser 135 is generally u-shaped, and is generally symmetrical about a vertical axis.

Steam permeable panel 136 is adapted to support food items to be steamed on steaming domes 138a and 138b. Steaming domes 138a and 138b are adapted to receive a food item placed thereon. Steaming domes 138a and 138b are also adapted to provide steam to a food item located above steaming domes 138a and 138b. Typically, steaming domes 138a and 138b are sized to direct steam substantially uniformly onto a food item such as a bun crown, a bun heel, or a tortilla.

Steam permeable panel 136 may be formed of any suitable steam permeable material preferably having a relatively low thermal conductivity and a relatively high temperature resistance, including but not limited to silicone, nylon or metal and may be in the form of a mesh or screen to allow steam to readily pass therethrough.

Steam permeable panel 136 may be attached to food item platform 134 in any suitable manner, including, but not limited to, the application of a thermally resistant adhesive or a mechanical fastener.

Food item platform 134 is connected to platform support 132 via a platform hinge 140. Platform hinge 140 includes at least one platform hinge attachment 142 mounted to a platform hinge bracket 144a and 144b, attaching food item platform 134 to platform support 132. Platform hinge 140 allows food item platform 134 to be rotated about an essentially horizontal axis in the direction of arrow Q by an operator using a platform handle 146. Typically, platform hinge 140 allows food item platform 134 to be rotated at least 180 degrees about an essentially horizontal axis.

When food item platform 134 is substantially engaged with platform support 132 as illustrated in FIGS. 15-18, food item platform 134 is in the food steaming position. Typically, food item platform 134 is generally horizontal when in the food steaming position.

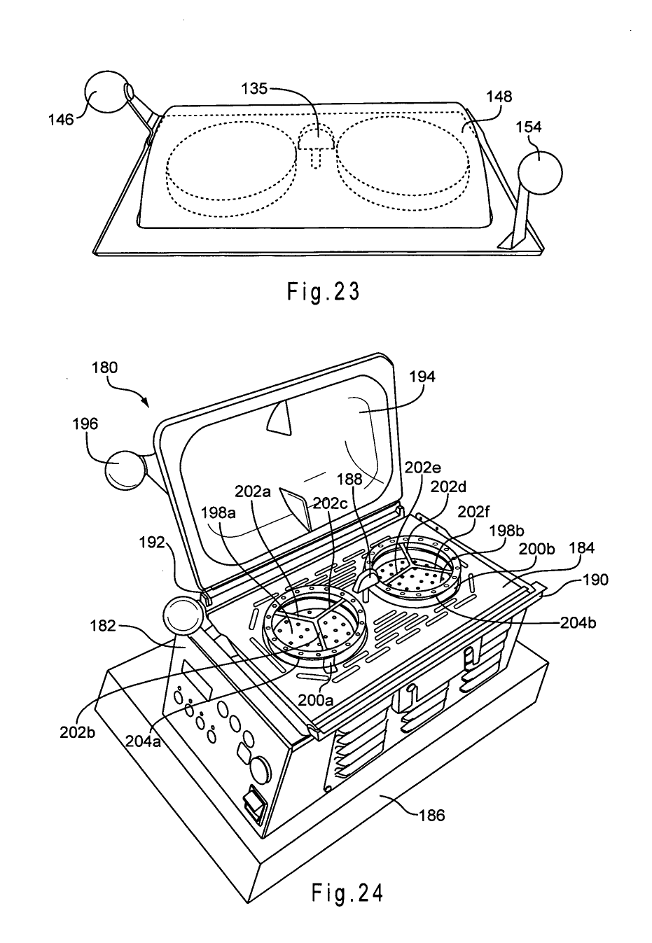

Steaming device 130 further includes a cover 148. Cover 148 is connected to platform support 132 via a cover hinge 150. When cover 148 is in the closed position, as illustrated in FIGS. 17 and 23, it essentially covers food item platform 134 to form a cavity 152. Typically, cover 148 is essentially rectangular in shape and has approximately the same width and length as food item platform 134. Cover hinge 150 allows cover 148 to be opened, exposing food item platform 134. Cover hinge 150 allows the cover 148 to be rotated about an essentially horizontal axis by an operator using a cover handle 154. Cover hinge 150 allows cover 148 to be rotated at least 90 degrees about an essentially horizontal axis in the direction of arrow P. Typically, cover hinge 150 allows cover 148 to be rotated at least 135 degrees about an essentially horizontal axis, providing clearance to allow food item platform 134 to be rotated via platform hinge 140.

Cover hinge 150 typically attaches cover 148 to platform support 132 on a different side from where platform hinge 140 attaches food item platform 134 to platform support 132. Cover hinge 150 can attach cover 148 to platform support 132 in a manner to rotate in a different direction from food item platform 134. Typically, cover hinge 150 attaches cover 148 to platform support 132 in a manner to rotate in the opposite direction from food item platform 134.

Optionally, food item platform 134 is situated in either a leftward pivoting or rightward pivoting orientation, allowing food item platform 134 to be rotated in either the clockwise or counterclockwise direction depending on the preferred mode of operation, and accommodating both right-handed and left-handed human operators. Cover 148 is situated in either a leftward pivoting or rightward pivoting orientation, allowing cover 148 to be rotated in either the clockwise or counterclockwise direction depending on the preferred mode of operation.

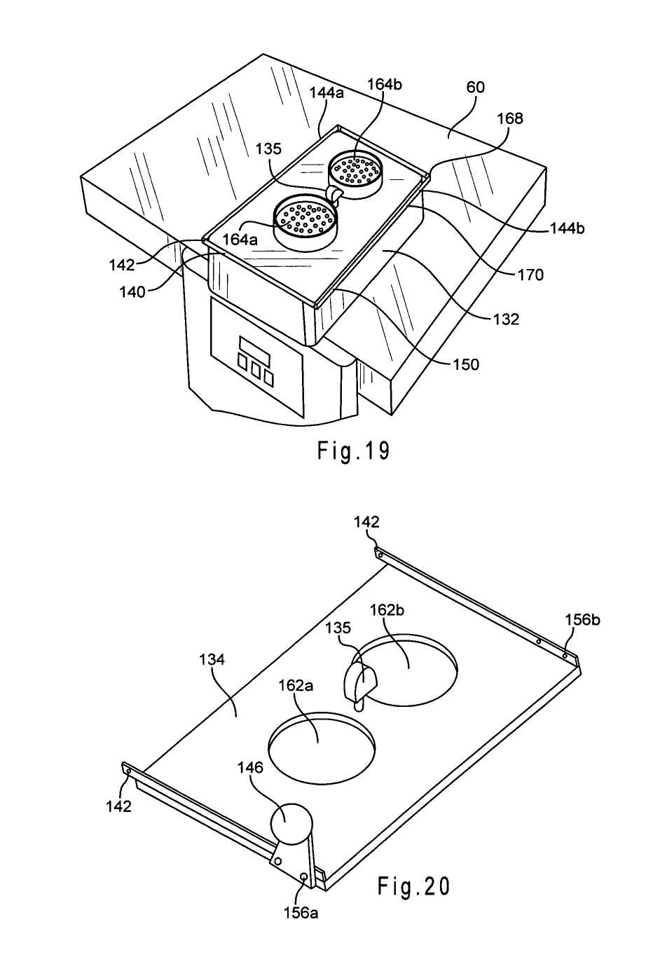

As illustrated in FIG. 20, food item platform 134 further includes alternate handle mounts 156a and 156b at adjacent corners to allow platform handle 146 to be attached at the appropriate corner to be accessible from the front of steaming device 130 in its leftward pivoting or rightward pivoting orientations. FIG. 19 is an illustration of platform support 132 with food item platform 134 and cover 148 detached therefrom, ready for each of food item platform 134 and cover 148 to be mounted to either hinge bracket 144a or hinge bracket 144b, illustrated in FIG. 19, as desired.

Steaming device 130 also includes a button 158 for activating steaming device 130. Steaming device 130 also includes an LED indicator 160 which indicates when the steaming process is complete. The steaming device may also include any other type of suitable indicator that steaming is complete, including, but not limited to, an audible signal.

FIG. 17 illustrates steaming device 130 in the closed position. Cover 148 is pivotally rotated to engage with platform support 132, forming cavity 152. Preferably, cover 148 cooperatively engages with platform support 132 to form steaming cavity 152 when steaming device 130 is in the closed position, to at least substantially retain steam inside cavity 152 during steaming. Steaming is initiated by an operator by activating button 158 or triggering any other appropriate actuator. A controlled quantity of steam is injected through steam permeable panel 136 once steaming is initiated. Typically, a food item is located on food item support riser 135, and is situated above steaming domes 138a and 138b, and is steamed from the controlled quantity of steam. The food item can be any food item that is to be steamed. Typically the food item is a tortilla, removed from FIG. 22 for clarity.

As illustrated in FIG. 20, to permit passage of steam from a steam source into tortilla T, food item platform 134 includes platform openings 162a and 162b, which communicate with steaming domes 138a and 138b, respectively. Platform support 132 includes steam outlets 164a and 164b, as illustrated in FIG. 19, which communicate with steaming domes 138a and 138b, respectively.

FIG. 15 illustrates steaming device 130 in the food steaming position, with a tortilla T located on food item support riser 135. Tortilla T is located above first and second steaming domes 138a, 138b and is ready to be steamed. Typically, cover 148 is rotated, and closed on food item platform 134 prior to steaming.

FIG. 16 illustrates steaming device 130 in the food steaming position, with a steamed tortilla S located on food item support riser 135. Steamed tortilla S is located above first and second steaming domes 138a, 138b and has been subjected to steam that passed through first and second steaming domes 138a, 138b. Cover 148 is open, and steamed tortilla S can be removed from steaming device 130 with any suitable device, such as with a pair of tongs.

FIG. 19 illustrates platform support 132. Platform support 132 includes platform hinge 140 and cover hinge 150. Platform hinge 140 includes platform hinge attachment 142 and platform hinge bracket 144a and 144b. Cover hinge 150 includes cover hinge attachment 168 and cover hinge bracket 170. Platform support 132 is ready for each of food item platform 134 and cover 148 to be mounted to either hinge 140 or 150, as desired.

FIG. 20 illustrates food item platform 134. Food item platform 134 includes platform openings 162a and 162b, which are slightly larger than steaming domes 138a and 138b as illustrated in FIG. 21. Platform hinge attachments 142 are adapted to connect food item platform 134 to a platform support of a steaming device. Food item platform 134 also includes platform handle 146. Platform handle 146 is attached to food item platform 134 via handle mount 156a. Alternatively, platform handle 146 can be attached to food item platform 134 via handle mount 156b.

FIG. 21 illustrates steam permeable panel 136. Steam permeable panel 136 includes steaming domes 138a and 138b. Steaming domes 138a and 138b are of the appropriate size and shape to accept placement of a food item thereon. Typically, steaming domes 138a and 138b are slightly larger than a hamburger bun and accept placement of a hamburger bun thereon. Food item support riser 135 is located between steaming domes 138a and 138b. Typically food item support riser 135 is the appropriate height and size to support a tortilla T above steaming domes 138a and 138b.

FIG. 22 illustrates steaming device 130, with cover 148 in the open position, and steaming device 130 ready to accept a food item such as a tortilla.

FIG. 23 illustrates steaming device 130, with cover 148 in the closed position.

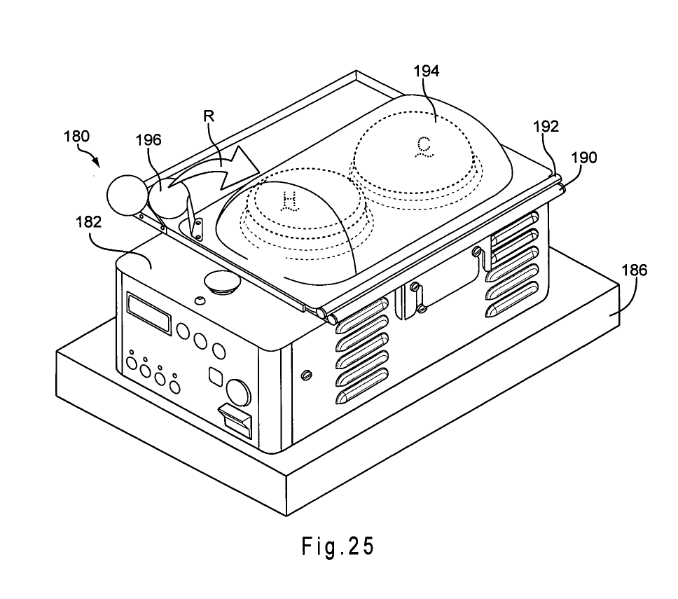

In another embodiment, as generally illustrated in FIGS. 24-25, food steaming device 180 is provided. Food steaming device 180 includes a platform support 182 which supports a food item platform 184. Platform support 182 can be of a desired shape and as shown is rectangular in shape and rests on a work surface 186. Platform support 182 can completely rest on work surface 186 without any portion of the device overhanging work surface 186. Food item platform 184 is typically rectangular or generally rectangular in shape, but can be any suitable shape as desired. Food item platform 184 includes a food item support riser 188. Platform support 182 includes platform hinge 190 and cover hinge 192.

Steaming device 180 further includes a cover 194. Cover 194 is connected to platform support 182 via a cover hinge 192. When cover 194 is in the closed position, it essentially covers food item platform 184 to form a cavity. Typically, cover 194 is essentially rectangular in shape and has approximately the same width and length as food item platform 184. Cover hinge 192 allows the cover 194 to be rotated about an essentially horizontal axis by an operator using a cover handle 196. Cover hinge 192 allows cover 194 to be rotated at least 90 degrees about an essentially horizontal axis in the direction of arrow R. Typically, cover hinge 192 allows cover 194 to be rotated at least 135 degrees about an essentially horizontal axis, providing clearance to allow food item platform 184 to be rotated via platform hinge 190. Platform hinge 190 and cover hinge 192 can be on the same side of food item platform 184 as illustrated in FIG. 25. Alternatively, platform hinge 190 and cover hinge 192 can be on opposite sides of food item platform 184 as illustrated in FIG. 24.

Platform support 182 includes steam outlets 198a and 198b. Steam outlets 198a and 198b include bun supports 200a and 200b. Bun supports 200a and 200b each include three support arms 202a-f, respectively. Bun support 200a includes three support arms 202a-c and bun support 200b includes three support arms 202d-f. Support arms 202a-c and 202d-f are about equally spaced radii in the form of a circular pattern in about the same size as steam outlets 198a and 198b. Steam outlets 198a and 198b also include a plurality of peripheral steam openings 204a and 204b. Peripheral openings 204a and 204b are located between steam outlets 198a, 198b and bun supports 200a, 200b. Peripheral openings 204a, 204b allow steam to pass through peripheral openings 204a, 204b and enter the cavity defined by cover 194 when rotated in the closed position to engage cover 194 with platform support 182. Steam can pass through the peripheral openings 204a, 204b to make a bun crown surface shiny while steaming the underside of the bun. Typically, it is intended for a bun crown or heel to be located on bun support 200a or 200b interiorly of peripheral openings 204a or 204b and the components of platform support 182 are appropriately sized to this end.

In an additional embodiment of the present invention, it is possible to place multiple steaming devices end to end, linearly arranged on a workspace. Such an arrangement would allow for multiple steaming devices to be contained within one housing. Each steaming device typically would contain its own set of controls, which could operate each of the steaming devices individually or together as a unit. Typically, two steaming devices would be placed end to end, linearly arranged on a workspace such as a counter, and contained within one housing. A user could access the steaming devices from either side of the workspace, allowing for operation of the steaming devices from either side of the workspace.

In another embodiment of the present invention, a method of producing a steamed food item is provided. A food steaming device of one of the types in accordance with the invention as previously described is provided. For example, the food steaming device includes a food item platform; a platform support; a platform hinge connecting the food item platform to the platform support, wherein the food item platform is pivotable between a food steaming position and a food removal position; a food item support riser connected to the food item platform; and a steam source communicating with a steam outlet, the steam outlet configured to direct steam onto the food item platform when the food item platform is in the food steaming position.

The food item platform is placed in the food steaming position. When in the food steaming position, the food item platform is substantially engaged with a platform support. An example of a food item platform in the food steaming position is illustrated in FIG. 15. Typically, the food item platform is generally horizontal when in the food steaming position.

A food item desired to be steamed is placed on the food item support riser. Any appropriate food item can be steamed. Typically, tortillas to be steamed are placed on the food item platform, overlaying, for example, both steaming domes 138a and 138b on steam outlets 198a and 198b, the tortilla also being supported by support riser 135, such as shown, for example, in FIGS. 15 and 16.

Steam is directed through the steam outlet and onto the food item for a period of time sufficient to essentially steam the food item. The time period sufficient to essentially steam the food item depends on the food item. For a typical tortilla or bread product, the period of time sufficient to essentially steam the tortilla or bread product is approximately 12 seconds. Any suitable steam source may be configured in communication with the steam outlets to provide controlled quantities of steam for injection into food items. For multiple steam outlets, each steam outlet may have its own steam source or may share a common steam source. Referencing schematic FIG. 2a, a common steam source 52 supplies steam to both steam outlets 50a and 50b, via respective heated sinks 54a and 54b. Steam outlets 50a and 50b are approximately circular in shape. Steam outlets may be any appropriate shape, such as oval or circular. Typically, the steam outlets are circular. A microprocessor control system 56 is provided for directing solenoids 58a and 58b to provide a water pulse to one of associated heated sinks 54a and 54b about 0.1 second before providing a water pulse to the other heated sink. Such staggering of water pulses has been found to promote more uniform water input to each heated sink than simultaneous water pulses.

When the food item is substantially steamed, or steamed a desired amount, the food item is removed from the food item support riser. Any appropriate apparatus to remove the food item may be used. Typically, tongs are used to remove the food item from the food item support riser.

In a further embodiment of the invention, apparatus is provided to send a signal when the food item is essentially steamed. The signal can be any appropriate signal, including, but not limited to, a visual signal, which may be an LED indicator. Alternatively, or in addition to the visual signal, an audible signal can also be utilized.

In another embodiment of the method aspects of the invention, a cover is provided. The cover is movable between an open position and a closed position on the platform support. Typically the cover is moved to the open position to permit placing a food item on the food item support riser. The cover is moved to the closed position, defining a cavity. The cavity typically comprises the food item and is configured to at least substantially retain steam. The cover engages with the platform support to provide a seal between the cover and the platform support, allowing the food to be steamed within the cavity. After steam is directed from the steam source through the food item, the cover is moved to the open position to permit the food item to be removed from the food item support riser.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A device for steaming a food item comprising:
a food item platform;
a platform support;
a platform hinge connecting the food item platform to the platform support, wherein the food item platform is pivotable between a food steaming position and a food removal position;
a food item support riser connected to the food item platform; and
a steam source communicating with a steam outlet, the steam outlet configured to direct steam onto the food item platform when the food item platform is in the food steaming position.

2. The device of claim 1 wherein the food item support riser is curved.

3. The device of claim 2 wherein the food item support riser is generally u-shaped and is generally symmetrical about a vertical axis.

4. The device of claim 1 wherein the food item platform is generally horizontal when in the food steaming position.

5. The device of claim 1 wherein the food item platform is pivotable at least 180 degrees from the food steaming position.

6. The device of claim 1 wherein the food item platform comprises a first steaming dome and a second steaming dome; wherein the first steaming dome and the second steaming dome direct steam through the food item platform and onto the food item.

7. The device of claim 6 wherein the food item support riser is located between the first steaming dome and the second steaming dome.

8. The device of claim 7 wherein the first steaming dome and the second steaming dome are sized to direct steam substantially uniformly onto a tortilla.

9. The device of claim 1 wherein the platform support comprises a plurality of platform mounts to allow the device to be mounted alternatively adjacent to a tabletop, mounted to the tabletop, and placed on the tabletop.

10. The device of claim 1 further comprising a cover, wherein the cover cooperatively engages the food item platform defining a cavity, the cavity comprising a seal to substantially retain steam in the cavity when the device is in the food steaming position.

11. The device of claim 1 wherein the food item platform comprises a food steaming panel comprising a steam permeable material.

12. The device of claim 11 wherein the food steaming panel comprises a first steaming dome and a second steaming dome, wherein both the first steaming dome and the second steaming dome direct steam through the food item platform and onto the food item.

13. The device of claim 1 further comprising an LED indicator light to provide a visual signal when steaming is completed.

14. The device of claim 1 further comprising an audible signal indicator to provide an audio signal when steaming is completed.

15. A method of producing a steamed food item comprising:
providing a device for steaming food comprising a food item platform; a platform support; a platform hinge connecting the food item platform to the platform support, wherein the food item platform is pivotable between a food steaming position and a food removal position; a food item support riser connected to the food item platform; and a steam source communicating with a steam outlet, the steam outlet configured to direct steam onto the food item platform when the food item platform is in the food steaming position;
placing the food item platform in the food steaming position;
placing a food item on the food item support riser;
directing steam from the steam source through the steam outlet and onto the food item for a period of time sufficient to essentially steam the food item; and
removing the food item from the food item support riser.

16. The method of claim 15 wherein the period of time sufficient to essentially steam the food item is approximately 12 seconds.

17. The method of claim 15 further comprising signaling that the food item is essentially steamed.

18. The method of claim 15 further comprising:
providing a cover comprising a cover hinge connecting the cover to the platform support, wherein the cover is movable between an open position and a closed position;
moving the cover to the open position to permit placing a food item on the food item platform;
moving the cover to the closed position to define a cavity, the cavity comprising the food item and configured to at least substantially retain steam; and
after steam is directed from the steam source, moving the cover to the open position to permit moving the food item platform from the food steaming position to the food removal position.

19. A device for steaming a food item comprising:
a food item platform;
a platform support;
a steam outlet on the platform support;
a bun support located on the steam outlet;
a peripheral slot located between the bun support and the steam outlet; and
a platform hinge connecting the food item platform to the platform support, wherein the food item platform is pivotable between a food steaming position and a food removal position; and
a steam source communicating with the steam outlet, the steam outlet configured to direct steam onto the food item platform when the food item platform is in the food steaming position.
